(19) United States
(12) Patent Application Publication
(10) Pub. No.: US 2007/0125138 A1
(43) Pub. Date: Jun. 7, 2007

(54) Securing axle assembly extending out and selectively rotatable relative to a casing of a lock assembly so as to secure an object when required

(76) Inventor: Tony Miao, Taishan Hsiang (TW)

Correspondence Address: HERSHKOVITZ & ASSOCIATES, 2845 DUKE STREET, ALEXANDRIA, VA, 22314, US

(21) Appl. No.: 11/293,198

(22) Filed: Dec. 5, 2005

(51) Int. Cl. E05B 73/00

(52) U.S. Cl. 70/58

(57) ABSTRACT

A lock assembly includes a securing axle rotatably extending out of the casing and having a threading formed on an upper portion thereof for threading connection to an object to be protected and a push movably received in the casing to be selectively engaged with a lower portion of the securing axle to allow the rotation of the securing axle to drive the push to rotate simultaneously such that when the securing axle is rotated, the lock assembly is rotated and the object to be protected is threadingly connected to the securing axle.

### BACKGROUND OF THE INVENTION

1. Field of the Invention

The present invention relates to a securing axle, and more particularly to a securing axle which extends out and is selectively rotatable relative to a casing of a lock so as to threadingly secure an object when required.

2. Description of the Prior Art

In a business show or in normal stores, different products are displayed on shelf so that customers are able to have direct access to the products. In order to prevent the products from being stolen by unauthorized personnel, the store owners or the responsible person will normally lock the product via a lock together with a steel cable such that the customer is able to hold the product to have a close look at it. But when the entire product line is to be replaced by a new product line, the person who is in charge will have to disconnect all the cables from the associated locks one by one and sometimes even cutoff the cables, which is quite troublesome and labor intensive for the user.

To overcome the shortcomings, the present invention tends to provide an improved securing mechanism to mitigate the aforementioned problems.

### SUMMARY OF THE INVENTION

The primary objective of the present invention is to provide a securing axle extending out and being selectively rotatable relative of a casing of a lock so that when the securing axle is fixed to the lock casing, the user is able to rotate the lock to threadingly extend the secure axle into an object to be protected, and when the securing axle is freely rotatable relative to the lock casing, the user is not able to unscrew the securing axle from the object such that unauthorized personnel is not have to detach the lock from the object protected.

In another objective of the present invention, the securing axle is provided with teeth mated with notches of a push movably extending into the lock so that the securing axle is immovable relative to the lock. Therefore, rotation of the lock will drive the securing axle to rotate so that the securing axle is able to threadingly extend into an object to be protected.

In yet another aspect of the present invention, the push has a first wedged face formed on a bottom face thereof to selectively mate with a second wedged face formed on a free end of a bolt of the lock so that the bolt of the lock is pushed away when the push is forced to extend into the lock for mating with the securing axle.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing the securing axle is extending out of the lock assembly;

FIG. 2 is an exploded perspective view showing the lock assembly and the securing axle as well as the push;

FIG. 3 is a schematic cross sectional view showing that the push is movably received in the lock assembly;

FIG. 4 is a schematic cross sectional view showing the movement of the push leads to the engagement between the push and the securing axle;

FIG. 5 is a schematic top plan view showing the engagement between the push and the securing axle;

FIG. 6 is a schematic view showing that the lock assembly having the securing axle received therein is applied to secure a camera;

FIG. 7 is a schematic cross sectional view showing a different embodiment of the securing axle and the push in the lock assembly;

FIG. 8 is a schematic cross sectional view showing the engagement between the push and the securing axle after the push is forced to extend into the lock assembly; and

FIG. 9 is a schematic top plan view showing the securing axle is securely received in the push.

### DETAILED DESCRIPTION OF THE PREFERRED EMBODIMENT

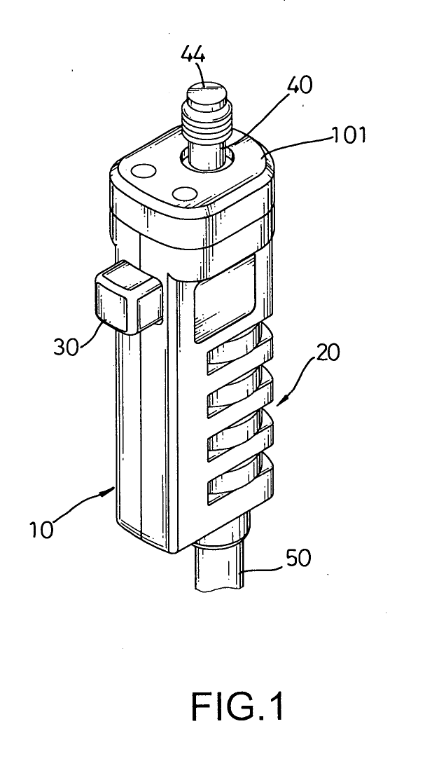

With reference to FIG. 1, it is noted that a securing axle (40) in accordance with the present invention is applied to a lock assembly having a casing (10) of two halves, a push (30) movably extending into the casing (10) and a cable (50) extending from a bottom of the casing (10).

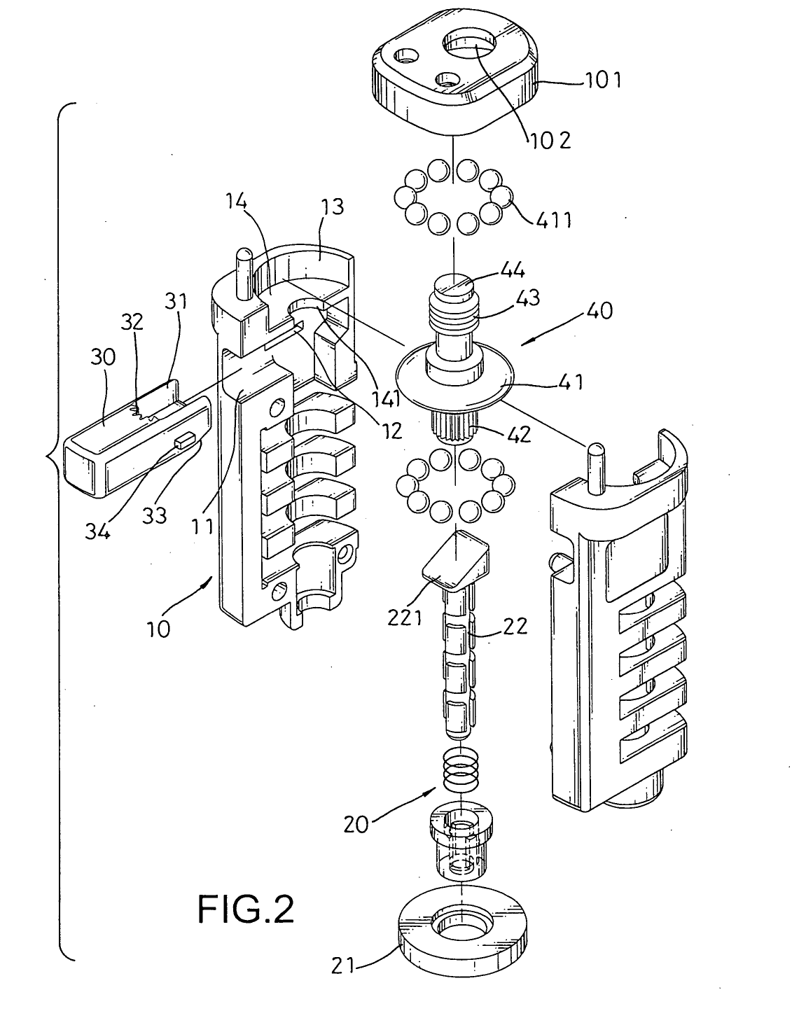

With reference to FIG. 2, the casing (10) defines therein a receiving space (not numbered) to receive a locking core (20). The casing (10) further has a chute (11) latitudinally defined to communicate with the receiving space and to receive therein the push (30), two recesses (12) respectively defined in each of the two halves of the casing (10) and in a side face defining the chute (11) to correspond to two bosses (34) respectively formed on two opposed sides of the push (30) and a compartment (13) defined in the casing (10) and separated with the receiving space of the casing (10) via a baffle (14) which has a hole (141) defined through the baffle (14) to allow the compartment (13) to communicate with the receiving space of the casing (10).

The lock core (20) includes a plurality of wheels (21) rotatably and partially received in the casing (10) and a bolt (22) extending through the wheels (21) to be movably received in the casing (10) and having a first wedged face (221) formed on a free end of the bolt (22) to correspond to a second wedged face (33) formed on a bottom face of the push (30). It is noted that because how the lock assembly works is not the focus of the present invention, description and structure thereof will not be addressed further hereinafter.

The push (30) further has a cutout (31) defined in an end thereof and multiple notches (32) defined in a bottom face defining the cutout (31).

The securing axle (40) includes a skirt (41) formed on a mediate portion thereof, multiple teeth (42) formed an outer periphery of a lower portion thereof to correspond to the notches (32) of the push (30), an outer threading (43) formed on an upper portion thereof and a pad (44) formed on a free end of the upper portion of the securing axle (40). In addition, multiple balls (411) are provided to both sides of the skirt (41) of the securing axle (40) to facilitate rotation of the securing axle (40). To secure the securing axle (40) inside the casing (10), the casing (10) further has a cover (101) securely attached to the casing (10) to encase the compartment (13) of the casing (10) and a through hole (102) defined through the cover (101) to communicate with the compartment (13).

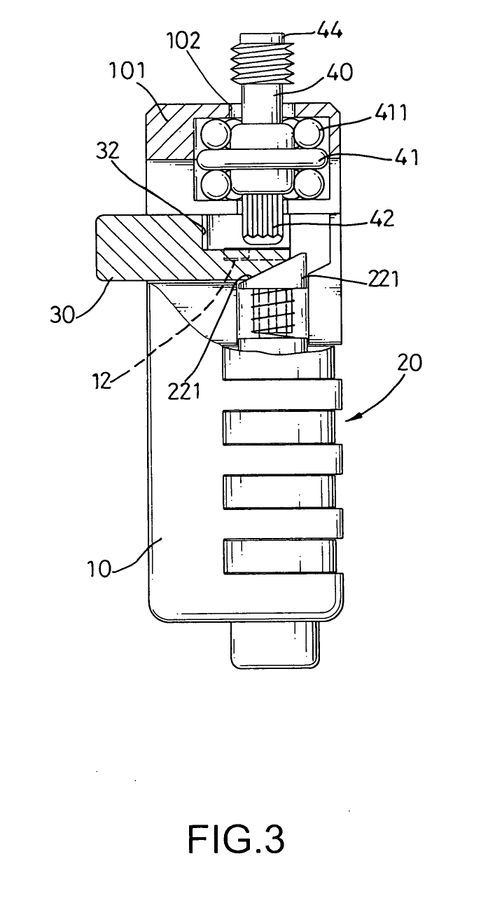

With reference to FIGS. 2 and 3, when the securing axle (40) as well as the push (30) is assembled in the lock assembly, it is noted that the push (30) is movably received in the chute (11) of the casing (10) and the securing axle (40) is rotatably received in and extends out of the casing (10). After the push (30) is received in the chute (11), the bosses (34) are movably received in the recesses (12) in the receiving space inside the casing (10) to regulate and facilitate movement of the push 30) inside the casing (10). Besides, due to the provision of the cover (101), the balls (411) are received in the compartment (13). The lower portion of the securing axle (40) extends into the receiving space of the casing (10) and the first wedged face (221) is in engagement with the second wedged face (33) of the push (30).

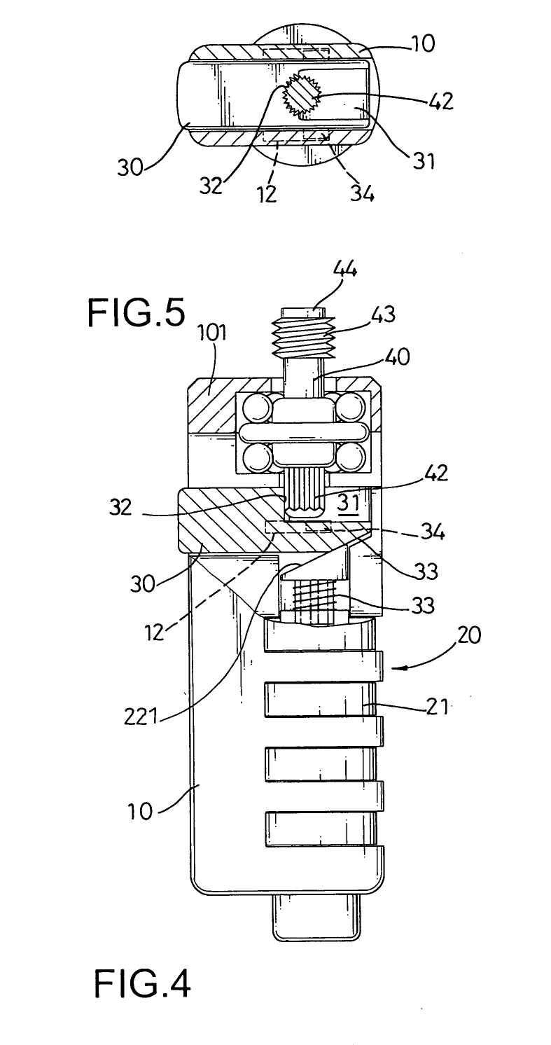

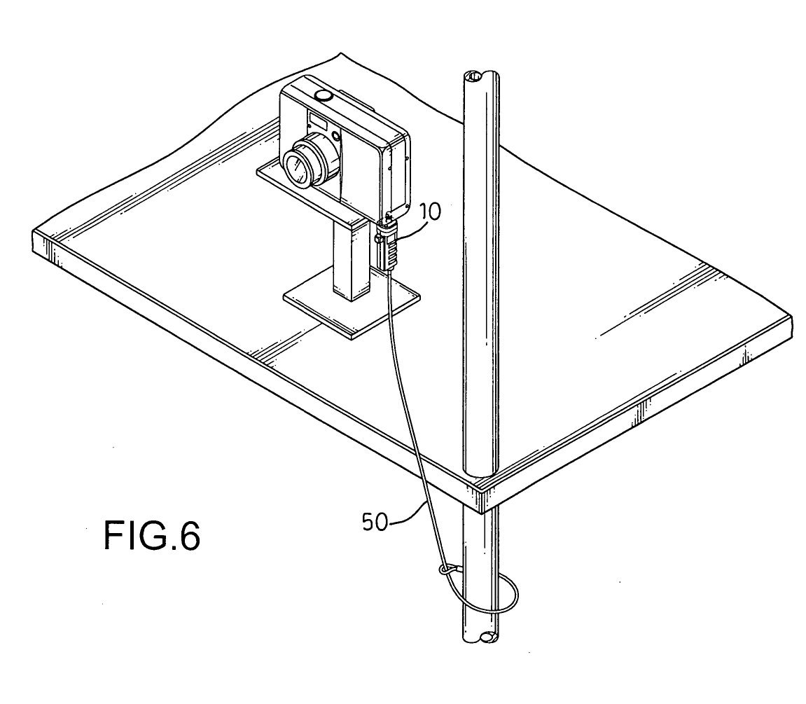

When the push (30) is extended further into the casing (10) to allow the teeth (42) to be received in the notches (32) of the push (30), as shown in FIGS. 4 and 5, there is no relative movement between the securing axle (40) and the push (30). That is, rotation of the casing (10) will drive the securing axle (40) to rotate as well. Therefore, after the lock assembly is assembled and in an unlocked status to allow the bolt (22) to move inside the casing (10), pushing the push (30) further into the casing (10) allows the teeth (42) to be received in the corresponding notches (32) and drives the bolt (22) to move in a direction away from the push (30). Then the user is able to use the threading (43) on the upper portion of the securing axle (40) to threadingly extend into the object to be protected. After which, the user may retract the push (30) from the casing (10) to allow the bolt (22) to move back to its original position. Then the user may use the locking mechanism to allow the lock assembly to be in a locked status such that the object is protected, as shown in FIG. 6. Any unauthorized personnel is not able to rotate the lock assembly by rotating the casing (10) because there is no substantial connection between the securing axle (40) and the lock assembly to allow the rotation of the securing axle (40) to drive the casing (10) to rotate simultaneously.

If the object is sold or for other reasons the lock assembly is no longer required, the user may unlock the lock assembly to once again allow the bolt (22) to move inside the casing (10). Then the user moves the push (30) to allow the teeth (42) to be received in the notches (32). Thereafter, rotation of the lock assembly drives the securing axle (40) to rotate simultaneously. Thus the user may remove the lock assembly form the object.

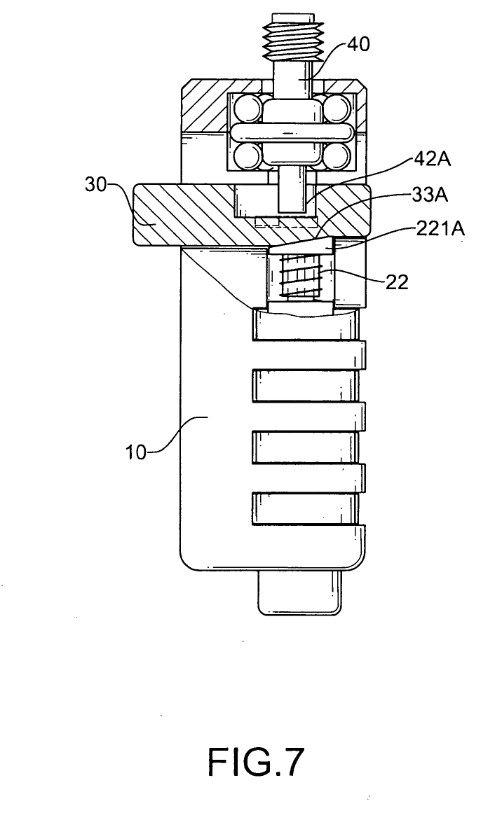

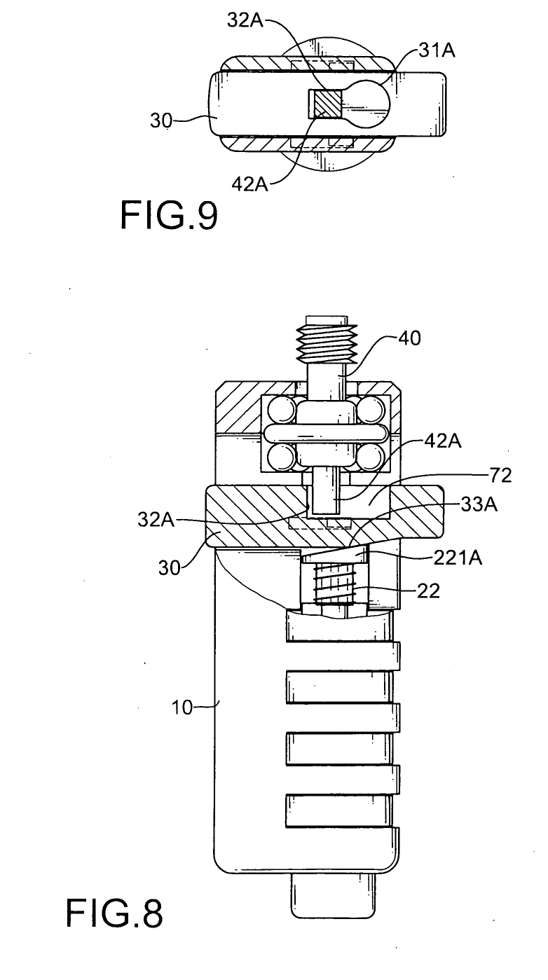

With reference to FIGS. 7 to 9, it is noted that the cutout (31) in the first embodiment is now changed to a keyhole (31A) composed of a circular hole and a elongated hole (32A) in communication with the circular hole and configured in a shape substantially the same as that of the lower portion of the securing axle (40). That is, when the bolt (22) is locked inside the casing (10), the bolt (22) is still received in the circular hole of the push (30). But when the push (30) is pushed further inside the casing (10), the bolt (22) is then received inside the elongated hole (32A) to limit movement of the bolt (22). Preferably, the elongated hole (32A) is configured to have a rectangular shape which is the same as that of the bolt (22) such that after the bolt (22) is received inside the elongated hole (32A), rotation of the lock assembly drives the securing axle (40) to rotate as well, which accomplishes the aforementioned objectives.

In short, the bolt (22) is movably received inside the casing (10) between two positions, one is the locked position and the other one is the unlocked position. When the bolt (22) is at the locked position, the first wedged face (221) of the bolt (22) forces the push (30) away from engagement with the securing axle (40) so that unauthorized personnel is unable to unscrew the object under protection by the lock assembly.

It is to be understood, however, that even though numerous characteristics and advantages of the present invention have been set forth in the foregoing description, together with details of the structure and function of the invention, the disclosure is for illustrative purpose only, and changes may be made in detail, especially in matters of shape, size, and arrangement of parts within the principles of the invention to the full extent indicated by the broad general meaning of the terms in which the appended claims are expressed.

What is claimed is:

1. A lock assembly having a casing, a bolt movably received inside the casing between a first position and a second position and a locking mechanism received in the casing to selectively secure the bolt in the first position when the locking mechanism is in a locked status and allow the bolt to move to the second position when the locking mechanism is in an unlocked status, wherein the improvements comprise:
a securing axle being rotatable relative to the casing and having a threading formed on an upper portion thereof for threading connection to an object to be protected; and
a push being movably received in the casing to be selectively engaged with a lower portion of the securing axle to allow the rotation of the securing axle to drive the push to rotate simultaneously such that when locking mechanism is in the unlocked status and the securing axle is rotated, the lock assembly is rotated and the object to be protected is threadingly connected to the securing axle.

2. The lock assembly as claimed in claim 1, wherein the securing axle has a skirt formed on a mediate portion thereof and balls received in both sides of the skirt to facilitate rotation of the securing axle inside the casing.

3. The lock assembly as claimed in claim 2, wherein the push is firmly engaged with the securing axle when the locking mechanism is in the unlocked status to allow the rotation of the securing axle to drive the casing to rotate.

4. The lock assembly as claimed in claim 1, wherein the securing axle is provided with teeth formed on a lower portion thereof to correspond to notches defined in the push such that when the teeth are received in the corresponding notches the push moves together with the securing axle.

5. The lock assembly as claimed in claim 2, wherein the securing axle is provided with teeth formed on a lower portion thereof to correspond to notches defined in the push such that when the teeth are received in the corresponding notches the push moves together with the securing axle.

6. The lock assembly as claimed in claim 3, wherein the securing axle is provided with teeth formed on a lower portion thereof to correspond to notches defined in the push such that when the teeth are received in the corresponding notches the push moves together with the securing axle.

7. The lock assembly as claimed in claim 4, wherein the push further has a cutout defined in a free end of the push and the notches are defined in a bottom face defining the cutout.

8. The lock assembly as claimed in claim 5, wherein the push further has a cutout defined in a free end of the push and the notches are defined in a bottom face defining the cutout.

9. The lock assembly as claimed in claim 6, wherein the push further has a cutout defined in a free end of the push and the notches are defined in a bottom face defining the cutout.

10. The lock assembly as claimed in claim 3, wherein the push has a circular hole to receive therein a lower portion of the securing axle and an elongated rectangular hole in communication with the circular hole and configured in such a way that after the lower portion of the securing axle is received in the rectangular hole, the rotation of the securing axle drives the push to rotate simultaneously.

11. The lock assembly as claimed in claim 1, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

12. The lock assembly as claimed in claim 2, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

13. The lock assembly as claimed in claim 3, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

14. The lock assembly as claimed in claim 4, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

15. The lock assembly as claimed in claim 5, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

16. The lock assembly as claimed in claim 6, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

17. The lock assembly as claimed in claim 7, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

18. The lock assembly as claimed in claim 8, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

19. The lock assembly as claimed in claim 9, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.

20. The lock assembly as claimed in claim 10, wherein a first wedged face is adapted to be formed on a free end of the bolt and a second wedged face is formed on a bottom of the push to mate with the first wedged face of the bolt such that when the bolt is at the first position, the push is forced out of the casing and when the push is forced to extend further into the casing, the bolt is pushed away in a direction away from the push.
